(19) United States
(12) Patent Application Publication
(10) Pub. No.: US 2005/0047577 A1
(43) Pub. Date: Mar. 3, 2005

(54) Technique for updating a private directory at an information/call center

(76) Inventor: Timothy A. Timmins, Tigard, OR (US)

Correspondence Address: Alex L. Yip;Kaye Scholer LLP, 425 Park Avenue, New York, NY, 10022, US

(21) Appl. No.: 10/651,358

(22) Filed: Aug. 29, 2003

(51) Int. Cl. H04M 3/42

(52) U.S. Cl. 379/218.01

(57) ABSTRACT

An information assistance service automatically updates contact information in a subscriber's contacts folder or private directory. The information assistance service receives changes to its public telephone number database, which includes name, telephone number, postal address, and possibly e-mail address, compares the information in the contacts folder to be updated with the changes to the public database, and replaces the information in the contacts folder with new information if the telephone number is included within the changes to the public database. The subscriber may choose to be notified before or after such replacement is made—if before, the user may approve the changes one-by-one or all together. The updating can be performed in substantially real-time, as soon as changes to the public database are received, or the updating can be performed less frequently than those changes are received. In the latter case, the changes made to the public database since the last update are kept track of. Alternatively, shadow record information about a contact may be derived when a contact is added to a contacts folder, and an intelligent search may be performed using the shadow record information to update the contact record.

### BACKGROUND OF THE INVENTION

The invention relates generally to an information assistance system and method. More specifically, the invention relates to a system and method for updating a database at an information/call center.

In a typical directory assistance call, a caller identifies to the operator the name and address (sometimes city or area code) of a party whose telephone number is desired. In response, the operator locates the desired destination telephone number using, e.g., a computer database. The destination number is then provided to the caller, e.g., by a voice server which provides automated voicing of the number, and the caller is afforded an option to be connected to the destination number without the need of first terminating the directory assistance call.

Information assistance is an extension of directory assistance. In addition to connecting a caller to a destination number, information assistance operators can provide concierge-type services such as a restaurant guide and reservation service, event ticketing and reservation service, hotel reservation and availability service, travel or flight reservation and ticketing services, ordering specific items such as flowers or food delivery, arranging transportation, and accessing entertainment guides. The use of information assistance to provide such concierge-type services is disclosed, e.g., in commonly-assigned, co-pending U.S. application Ser. No. 09/520,306, “Technique for Providing Information Assistance Including Concierge-Type Services,” filed Mar. 7, 2000, incorporated herein by reference.

In addition, if a caller subscribes to an information assistance service, the information assistance service may develop one or more user profiles that include information pertaining to and about the caller, including preferences for handling calls from the caller and methods of identifying the caller based on the caller's telephone number and/or voiceprint. These profiles may also include the caller's personal preferences about restaurants, movies, sporting events, or hobbies.

Moreover, information assistance service subscribers may use the service to retain information folders set up by the caller, such as contacts folders (also known as private directories), appointments folders (also known as calendars), to-do lists, and notes. The caller may access the information assistance service in order to connect to a contact, retrieve an appointment or to-do list item, or set up a new contact, appointment, or to-do list item. The use of information assistance to provide these types of information management services and to maintain the folders is disclosed, e.g., in U.S. Pub. No. 2002/0055351 A1, published May 9, 2002, incorporated herein by reference.

### SUMMARY OF THE INVENTION

Over time, a contacts folder (private directory) may become obsolete as contacts move and change phone numbers. Typically, the telephone numbers and addresses in such a private directory are not updated, so if some amount of time has elapsed between calls to a certain telephone number, there is a chance that the telephone number will have changed, necessitating the information assistance service to look up the new number. This is an annoyance and a waste of both the user's and information assistance operator's time. The invention helps avert such a situation by automatically and/or systematically updating a user database such as a contacts folder.

In accordance with the invention, the information assistance service, which maintains the contacts folder (user's database) and one or more directory databases that contain information accessible to the public, receives changes to the directory databases, compares trackable information in the contacts folder, such as a telephone number, postal or e-mail address, or name, with the changes to the directory databases, and replaces the trackable information in the contacts folder with new information if the trackable information is included within the changes to the directory databases. The owner of the contacts folder may choose to be notified before or after such replacement is made, and may approve any proposed change on a global or item-by-item basis. In one aspect of the invention, the updating can be performed in substantially real-time, as soon as changes to the directory databases are received. In another aspect of the invention, the updating can be performed less frequently than those changes are received. In the latter case, the changes made to the directory databases since the last update are kept track of.

In another aspect of the invention, the information assistance service receives trackable information associated with a contact, uses the trackable information to obtain secondary information associated with the contact, and occasionally uses the trackable information to obtain additional secondary information associated with the contact. If the additional secondary information differs from the secondary information, the trackable information for that contact has likely changed, and the information assistance service updates the trackable information. This updating may be done by intelligently searching the directory databases for new trackable information based on the secondary information and then replacing the trackable information in the contacts folder with new trackable information based on the intelligent search.

Advantageously, the invention automatically updates the contact listings in a user's folder so that the next time the user can access accurate contact information in the folder, thereby avoiding any disruption or delay in contacting a desired party.

### BRIEF DESCRIPTION OF THE DRAWINGS

The accompanying drawings, in which like reference numerals represent like parts, are incorporated in and constitute a part of the specification. The drawings illustrate presently preferred embodiments of the invention and, together with the general description given above and the detailed description given below, serve to explain the principles of the invention.

FIG. 1 illustrates a communications system including information/call centers in accordance with an embodiment of the present invention;

FIG. 2 illustrates a system for connecting a caller terminal to an information/call center in accordance with an embodiment of the present invention;

FIG. 3 illustrates an information assistance service provider and a servicing platform for providing an information assistance service;

FIGS. 4A and 4B illustrate a routine for real-time updating a contact's telephone number in accordance with an embodiment of the present invention;

FIGS. 5A and 5B illustrate a routine for updating a contact's telephone number less frequently than in real-time in accordance with an embodiment of the present invention; and

FIGS. 6A and 6B illustrate a routine for updating a contact's telephone number using intelligent searching in accordance with an embodiment of the present invention.

### DETAILED DESCRIPTION

The present invention is directed to automatically updating contacts folders (also known as private directories) maintained at an information/call center. The initial contents of the directories are provided by users (or callers) who use the information/call center to retain their contacts folders.

Details regarding the contacts (and other) folders and information accessible to an information/call center can be found in above-referenced U.S. Pub. No. 2002/0055351 A1. In particular, a contacts folder contains contact information, such as telephone number, postal address, and e-mail address, for people and/or organizations. Each of the user's contacts includes at least a telephone number, and likely includes an associated name, which may be a full or real name of the contact (e.g., Joseph Johnson) or may be a nickname or alias (e.g., Joe or “JJ”). The associated address may be a full address, including number, street, city, state, postal code, and country, or may be a partial address, e.g., only including a street name or a city. A user may have separate contacts folders for different purposes, such as a personal contacts folder, a business contacts folder, a sports team contacts folder, etc. These folders are stored in a database accessible to an information/call center and its operators. The user may have specific rights with respect to a folder, e.g., owner, administrator, read-only, etc. When the user accesses a folder through an operator, the operator becomes an alter ego of the user and is subject to the same rights as the user with respect to the folder. The user may create, maintain, or access a contacts folder via the Internet or other communications means, or through an operator who in turn may create, maintain, or access the folder on behalf of the user. The user may be identified by an ANI (automatic number identification) or, alternatively, by, or in combination with, a user identification (ID), password, PIN (personal identification number), mother's maiden name, user voice recognition, user voiceprint, etc.

An expansive network of information/call centers may be used where operators can effectively provide users with personalized information and communications services. Such services may include, e.g., providing directory information, movie listings, restaurant recommendations, directions to various places, etc.; making reservations; sending invitations; administering appointment calendars; ticketing; and conducting other transactions for the users. The term “operator” used herein broadly encompasses entities that are capable of providing information assistance in a telecommunications environment, including, without limitation, human operators, voice response/recognition capabilities, web-/WAP-enabled operator services, and other automated and electronic access.

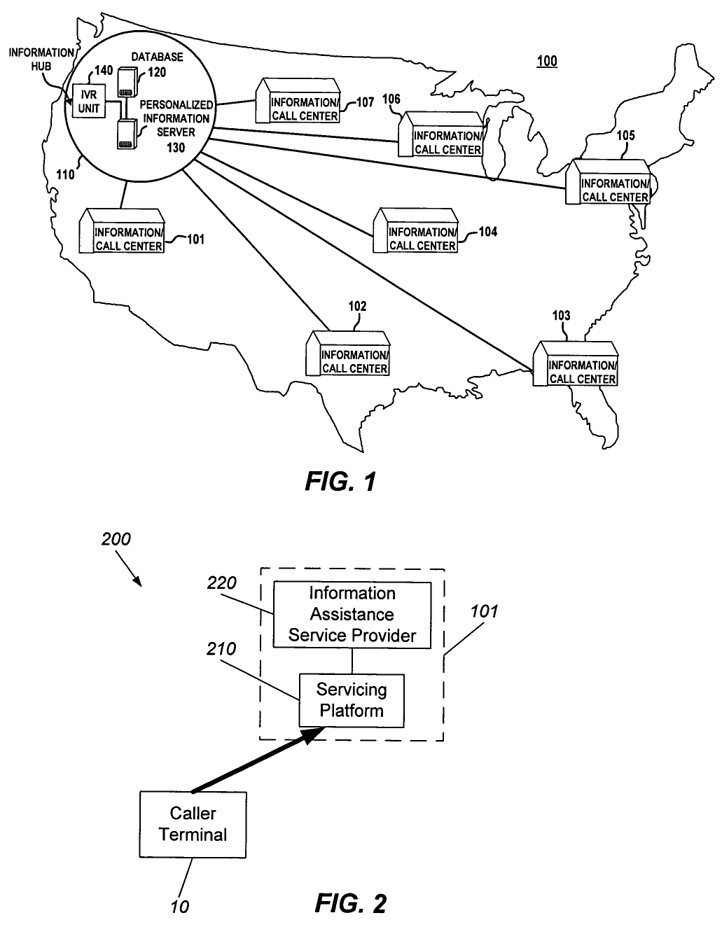

FIG. 1 illustrates a system embodying aspects of the invention, which includes wide area network (WAN) 100 covering an extensive area. WAN 100 can be an Internet-based network such as the World Wide Web or a private, intranet-based network. In this illustrative embodiment, WAN 100 connects operators dispersed throughout a wide coverage area in information/call centers 101-107. Each of information/call centers 101-107 covers one or more regional coverage areas. One or more information hubs 110 are also included in WAN 100. An information hub 110 includes one or more personalized information servers 130 which are accessible by the operators in the system and one or more databases 120 in which users' contacts, appointments, and other folders and information are stored and maintained. Information hub 110 may also include interactive voice response (IVR) unit 140 connected to server 130 for interacting with the user by voice, e.g., announcing to the user selected appointments. In addition to storing folders and information in information hub 110, they may also be stored locally at one or more of the information/call centers. The folders and information at different centers are synchronized. Synchronized databases provide necessary backup as well as support to roaming mobile device users.

In operation, the user dials a designated access number, and the call is routed to, say, information/call center 101 where an operator attends to the call. In the case in which the user desires an information assistance service, such as a directory assistance, information management, or concierge-type service, the user makes such a request to the operator and the operator accesses personalized information server 130 through WAN 100 (or alternatively via the Internet). In response, server 130 presents on the operator's terminal various graphical user interface (GUI) dialog boxes, e.g., “login” (for confirming the user's identity via User ID and password), “home” (listing the user's contacts, appointments, and other folders), “edit” (for editing specific folder contents), and “view” (for viewing folder contents), for interacting with the operator.

FIG. 2 illustrates system 200 in which a caller initiates an information assistance call from caller terminal 10, which is routed to, say, information/call center 101 via one or more carrier switches in a carrier network, e.g., a public switched telephone network (PSTN), a wireless telephone network, etc. Information/call center 101 generically represents any of the aforementioned information/call centers 101-107 shown in FIG. 1. Caller terminal 10 may comprise a wireless telephone, wireline telephone, personal digital assistant (PDA), computer, or other communication device. In this illustrative embodiment, users may dial, speak or otherwise communicate predetermined access digits, access codes or retail numbers, or input a predetermined address or URL (uniform resource locator) established by the carrier to access information/call center 101. For example, the predetermined access digits may be “411,” “*555,” “555-1212,” “00,” etc. Once connected to information/call center 101, the user requests information assistance.

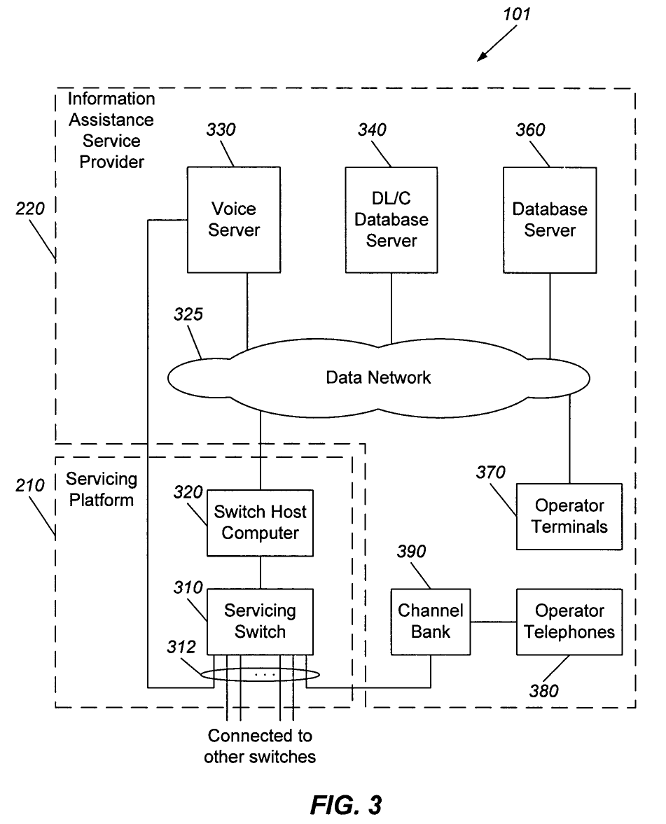

FIG. 3 illustrates information/call center 101, which may be configured to include information assistance service provider 220 together with servicing platform 210. It should be noted that even though both provider 220 and servicing platform 210 appear in the same figure, they may or may not be located in the same geographic area. Servicing platform 210 includes servicing switch 310 having T1 spans 312 or connections by other means for connection to one or more voice servers 330 (although only one is shown in the figure), channel bank 390, and one or more carrier networks. In an alternate embodiment, voice information may be packetized and transmitted pursuant to a VoIP (voice over IP (Internet Protocol)) protocol over a packet-switched network, e.g., the Internet, to information/call center 101. Servicing switch 310 may receive an incoming information assistance call from a carrier switch in a carrier network. Servicing switch 310 may also be used to place an outgoing call onto a carrier network, which may be different from the carrier network used for the incoming call.

Channel bank 390 in service provider 220 is used to couple multiple operator telephones 380 to servicing switch 310. The operators in information/call center 101 are further equipped with operator terminals 370, each of which includes a video display unit and a keyboard with an associated dialing pad. Operator terminals 370 are connected over data network 325 to one or more database servers 360 (although only one is shown in the figure). Operators may use database server 360 to provide information assistance including searching various databases in a manner described below to satisfy a caller's request. Other information assistance concerning restaurant recommendations, movie listings, events, etc. may also be provided by searching one or more internal and external databases, and the Internet. Switch host computer 320 and voice server 330 are also connected to data network 325. By way of example, data network 325 includes a local area network (LAN) supplemented by a number of point-to-point data links. Through data network 325 and routers (not shown), components of information/call center 101 may also be connected to the Internet or other wide area networks (WANs).

Servicing switch 310 is conventional and supports digital T1 or perhaps other connectivity. The operation of servicing switch 310 is governed by instructions stored in switch host computer 320. In this illustrative embodiment, servicing switch 310 includes, among other things, arrays of digital signal processors (DSPs). These DSPs can be programmed and reprogrammed to function as, among other things, call progress analyzers (CPAs), call progress generators (CPGs), multi-frequency (MF) tone generators/detectors, voice recognizers, dual-tone multi-frequency (DTMF) generators/detectors, or conference units, depending on the demand placed on information/call center 101 and servicing switch 310 for each corresponding function.

An incoming call requesting information assistance is received by servicing switch 310 in information/call center 101, which connects it to an available operator's telephone. If no operator is available when a call is received, the call is queued in a conventional manner until an operator becomes available. In this instance, automatic call distribution (ACD) logic of conventional design (not shown) is used to queue and distribute calls to operators in the order in which they are received, and such that the call traffic is distributed evenly among the operators. The ACD logic may reside in host computer 320 or elsewhere in information/call center 101. In other instances, other distribution logic schemes may be utilized, such as skills-based routing or a priority scheme for preferred users. In a preferred embodiment, when the information assistance call is received by servicing switch 310 in information/call center 101, switch 310 derives, in a well-known manner, from the signaling associated with the call the caller's phone number from which the call originates, known as ANI.

Voice server 330 (also known as a “voice response unit” or “VRU”) is used to play the constant repeated parts of an operator's speech, namely, the various greetings and signoffs (or closings) as well as other information portions of a call. Voice server 330 is connected via data network 325 to switch host computer 320 and via one or more T1 spans 312 to servicing switch 310. Voice server 330 may comprise a general-purpose computer and one or more voice cards for voice recognition, voice recording and playback, and call progress analysis. At appropriate stages in a call progression, switch host computer 320 initiates a voice path connection between voice server 330 and servicing switch 310 such that the user, or the user and the operator, are able to hear whatever pre-recorded speech is played on that connection by voice server 330. Computer 320 then instructs voice server 330, via data network 325, what type of message to play, and passes data parameters that enable voice server 330 to locate the message appropriate to the call state.

Data network 325 may further connect to directory listing/concierge (DL/C) database server 340. DL/C database server 340 may contain directory listing information on restaurants, events, accommodations, transportation, travel information and booking, stock prices, weather, and other services such as grocery or flower delivery, etc. Together, DL/C database server 340 and database server 360 provide operators with the means to search for a caller's desired party and determine the appropriate telephone number. Preferably, these databases can search not only by name and address, but also by type of goods/services and/or geographical region, or by any other attribute in the caller record, including phone number. For example, DL/C database server 340 can answer queries soliciting the names/numbers of restaurants serving a desired cuisine on a given street.

As time goes by, information in a contacts folder, e.g., telephone numbers, postal and e-mail addresses, and possibly names therein, may change. People move, telephone area codes are added or changed, telephone numbers are disconnected, businesses move or go out of business, people change their e-mail addresses or internet service providers, people get married, etc. If the telephone number for a contact is not updated, the next time the user tries to access the contact, the user may get a wrong or disconnected number. In order to avoid this inconvenience, the invention automatically updates the telephone numbers and other contact information associated with contacts. This updating can be accomplished in a number of ways, which are illustrated herein.

One methodology of updating the user's contacts folder is to do so in “real-time” based on updates to a general directory assistance database or other pertinent databases (referred to collectively as the “DA database”). If the DA database is updated once a day, so are the contacts folders. This methodology tracks the information, here the telephone numbers, in the contacts folders, and is performed as often as updates are made to the DA database. A second methodology of updating the user's contacts folder is also based on updates to the DA database, but the update to the user's contacts folder is performed not in real-time and thus less frequently than the aforementioned real-time methodology. Changes to the DA database are recorded in an index, and the index is searched when it is time to update the contacts folder. This second methodology also tracks the telephone numbers in the contacts folders. However, an index must be kept and performing an update can be somewhat labor-intensive. A third methodology of updating the contacts folder is to maintain a shadow record of each contact, where the contact may be identified in the user's contacts folder by a nickname or alias, which is the usual method of identifying contacts. This shadow record may contain identifying information about the contact (such as full name, address, and telephone number). When an update is to be performed, a search of the DA database is made using the shadow record information, and the contact information is updated if the current telephone number found using the shadow record information is different from before. This methodology differs from the first two because it relies on a contact's name and telephone number to create the shadow record. However, it does not require DA database changes to be kept in an index, and it can be performed less frequently than the real-time methodology. The three methodologies are described in more detail below, generally using updates to telephone numbers as an example.

The first methodology, “real-time” updating, is performed as frequently as updates are made to the DA database. As is well known, the DA database contains the names, telephone numbers, and addresses of individuals and businesses (e.g., all individuals and businesses in the United States) and is used by the information assistance service in the prior art to find a telephone number associated with a name. Thus, as previously mentioned, a user of the information assistance service may access the service by calling a designated number, e.g., “411,” “*555,” “555-1212,” “00,” etc., and request to be connected to Joseph Johnson of Miami, Fla. The information assistance service uses the DA database to find a telephone number for Joseph Johnson of Miami, Fla. In the event more than one listing satisfies those criteria, other information such as street address or zip code may help narrow the choices.

The DA database may include names, telephone numbers, and addresses compiled based on sources of information from a variety of local telephone companies (local exchange carriers) and other carriers (e.g., inter-exchange carriers or IXCs). Typically, the LECs and IXCs provide to the information assistance service information concerning changes in their directory databases, and the information assistance service then incorporates the changes into the DA database. Because a change in a telephone number is often the result of a party moving, a change in a directory listing for that party typically occurs in pairs, whereby a first change may be to delete the party's old number from the previous address and the second change may be to add the new number for the new address. The pair of changes may be linked, e.g., by the name of the party or the name on the account.

A real-time updating of a user's contacts folder may occur automatically after the DA database has been updated with these changes (e.g., once per day). The user may choose real-time updating for some or all of the contacts in the folder. For each telephone number in a contacts folder subject to real-time updating, the information assistance service compares the telephone number to telephone numbers included in the most recent changes to the DA database. If the telephone number is included in one of the most recent changes, such as the deletion of the telephone number from the DA database, the information assistance service determines the new telephone number added to the DA database as part of the delete/add pair, and updates the contact in the user's contacts folder. For example, a contact's telephone number may be listed as 825-555-2334. The information assistance service compares 825-555-2334 with the most recent changes to the DA database. If the most recent changes include “delete 825-555-2334” associated with a party, the information assistance service looks for the linked “add” change, e.g., “add 825-555-5667” associated with the same party, and updates the user's contacts folder to associate 825-555-5667 with the contact. In order to maintain a history of changes, the information assistance service preferably retains with the new telephone number at least the old telephone number and the date and time the update was made. If the user desires, before the information assistance service actually updates the contacts folder, the information assistance service may notify the user for permission to complete the update, and the user may approve the changes on a global or item-by-item basis. Alternatively, the information assistance service may notify the user of the update after it is completed. This notification may be via e-mail, fax, instant messaging (IM), short message service (SMS), voicemail, etc.

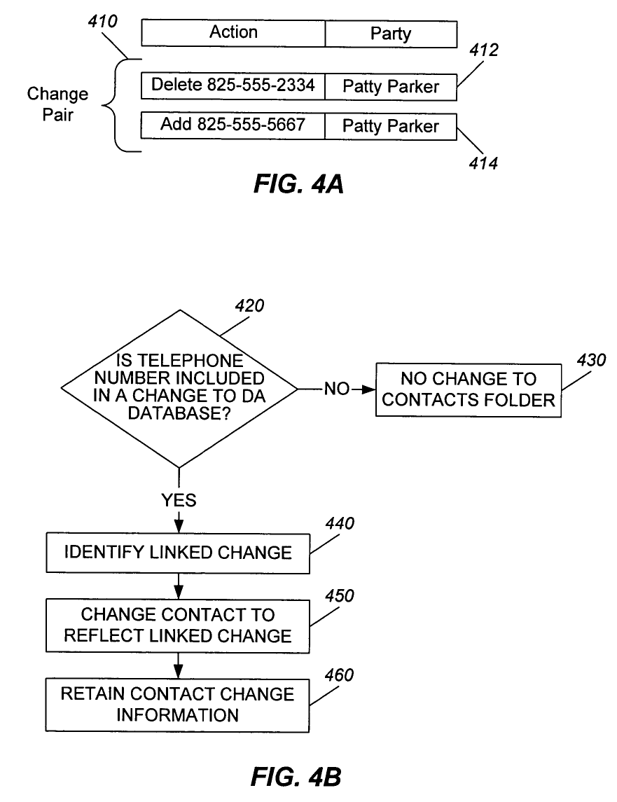

FIGS. 4A and 4B illustrate this real-time updating. FIG. 4A shows a change pair 410 consisting of two records 412, 414. Record 412 includes an action, e.g., “delete 825-555-2334,” and a link, e.g., a party's name, such as “Patty Parker.” Record 414 includes an action, e.g., “add 825-555-5667,” and a link to the same party. FIG. 4B shows a flowchart for updating a contacts folder. Step 420 asks whether the telephone number, e.g., 825-555-2334, of the contact is included in a change to the DA database, such as in a change pair. If not, step 430 makes no change. If there is a change to the DA database for that telephone number, e.g., record 412, step 440 uses the link, here the party's name, to identify the change linked to that number, e.g., record 414. Step 450 changes the contact's telephone number to reflect the linked change, and step 460 retains the contact change information. As mentioned above, this flowchart may be modified to require notifying the user before and/or after updating the contact.

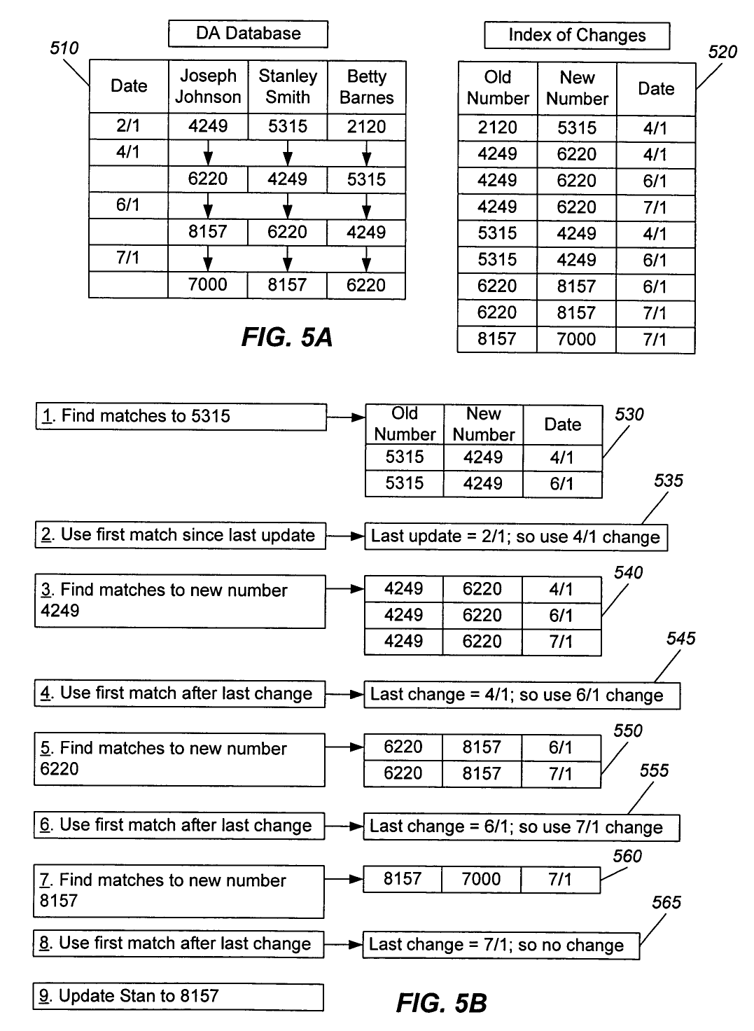

The second methodology is an extension of the real-time methodology and offers users the option of occasional or periodic updates rather than real-time updates. The DA database is provided with the same changes as before, e.g., on a daily basis, but, in this scenario, the information assistance service retains the history of the changes since the last update, preferably indexing the changes so as to facilitate the updating process and noting when the date and time of the change. When the time for updating the user's contacts folder occurs, the information assistance service compares the telephone number to be updated to telephone numbers included in the index of changes to the DA database. If the telephone number is included in the index of changes, such as the deletion of the telephone number from the DA database, the information assistance service determines the new telephone number added to the DA database as part of the delete/add pair and when the telephone number was changed. In order to be complete, the information assistance service must check to make sure the new telephone number did not change more than once since the last update. The information assistance service thus compares the new telephone number to telephone numbers included in the index of changes to the DA database. If the new telephone number is included in the index of changes, the information assistance service determines when the original number was changed and when the new number was changed. If the new number was changed after the original number was changed, then the information assistance service center must determine the subsequent new number; if the new number was changed before the original number, then the new number is likely the current number. This scenario is illustrated in FIGS. 5A and 5B.

FIG. 5A includes a directory 510 of telephone numbers (part of the DA database), simplified for illustration to four digits (e.g., as opposed to ten digits, according to the North American Numbering Plan), of three individuals, Joseph Johnson, Stanley Smith, and Betty Barnes. By way of example, Joseph, Stanley, and Betty all have their phone numbers changed at the same time, with Stanley following Joseph and Betty following Stanley. That is, when Joseph gets a new phone number, Stanley gets Joseph's old phone number at the same time and Betty gets Stanley's old phone number at the same time. On 2/1, the date of an update to a user's contacts folder, Joseph's number is 4249, Stanley's is 5315, and Betty's is 2120. Two months later, on 4/1, Joseph's number changes to 6220, Stanley gets Joseph's old number (4249), and Betty gets Stanley's old phone number (5315). Two months later, on 6/1, Joseph's number changes to 8157, Stanley's changes to 6220, and Betty's changes to 4249. Finally, one month later, on 7/1, Joseph's number changes to 7000, Stanley's changes to 8157, and Betty's changes to 6220.

The user in this case wants Stanley's number updated in the user's contacts folder every six months. At the time of the last update, 2/1, Stanley's number was 5315. What is his new number? The invention keeps track of the DA database phone number changes in an index of changes 520, which includes the old number, the new number, and the date of the change. Each change is a consolidation of a change pair, e.g., change pair 410, having a common link, here the name of the party to whom the telephone number is assigned. The index is arranged numerically to facilitate searching. FIG. 5B demonstrates the steps taken to update Stanley's number. Step 1 finds matches in index 520 where the old number is Stanley's old number, 5315. This yields result 530, which has two entries, both with changes to 4249, but occurring on different dates. Step 2 chooses the first match since the last update. Result 535 shows that since the last update was on 2/1, the 4/1 change will be used. The next step is to see whether the new number, 4249, changed since 4/1. Step 3 finds matches in index 520 to the new number, 4249. This yields result 540, which has three entries, all with changes to 6220, but occurring on different dates. Step 4 chooses the first match since the last change. Result 545 shows that since the last change was on 4/1, the 6/1 change will be used. The next step is to see whether the subsequent new number, 6220, changed since 6/1. Step 5 finds matches in index 520 to the subsequent new number, 6220. This yields result 550, which has two entries, both with changes to 8157, but occurring on different dates. Step 6 chooses the first match since the last change. Result 555 shows that since the last change was on 6/1, the 7/1 change will be used. The next step is to see whether the newest number, 8157, changed since 7/1. Step 7 finds matches in index 520 to the newest number, 8157. This yields result 560, which has one entry, with a change to 7000, occurring on 7/1. Step 8 chooses the first match since the last change, but result 565 shows that since the last change to Stanley's number was on 7/1, the change in result 560 will not be used. Because there are no more changes, step 9 determines that Stanley's number is currently 8157 and updates the user's contacts folder to that number. As before, the user may have the option of being notified of the update by the information assistance service either prior to or after the updating, and the user can approve the changes on a global or item-by-item basis.

The user has the option of choosing how often the contacts folder is updated. The more often it is updated, the fewer changes are likely to occur to a contact's telephone number between updates. The information assistance service may charge the user different prices for different updating schedules, and/or may charge per update. For instance, it may cost the information assistance service more per update to perform updates after long periods, e.g., a 6-month update costs more than a 1-month update, but it may cost more to perform six updates in six months than one every six months. The information assistance service should retain telephone number changes for as long as the longest update period, so storage may add to the costs.

Whereas the first two methodologies are based on the telephone numbers in the private directory and involve tracking changes to the DA database and keeping a history of those changes, a third methodology of updating the private directory relies instead on tracking other identifying information about a contact. Thus, unlike the first two methodologies, this methodology does not track the history of the telephone number, but retrieves the latest telephone number associated with the contact name. A problem therefore arises if the name given to the contact (e.g., “Sue”) differs from the name in the DA database (e.g., “Susan Smith”) associated with the telephone number. This problem is solved in this methodology by, when a user adds a contact to a contacts folder, having the information assistance service derive as much information about the contact from the DA database, retain that information in a “shadow” record, and use the information in the shadow record when it is time to update the telephone number.

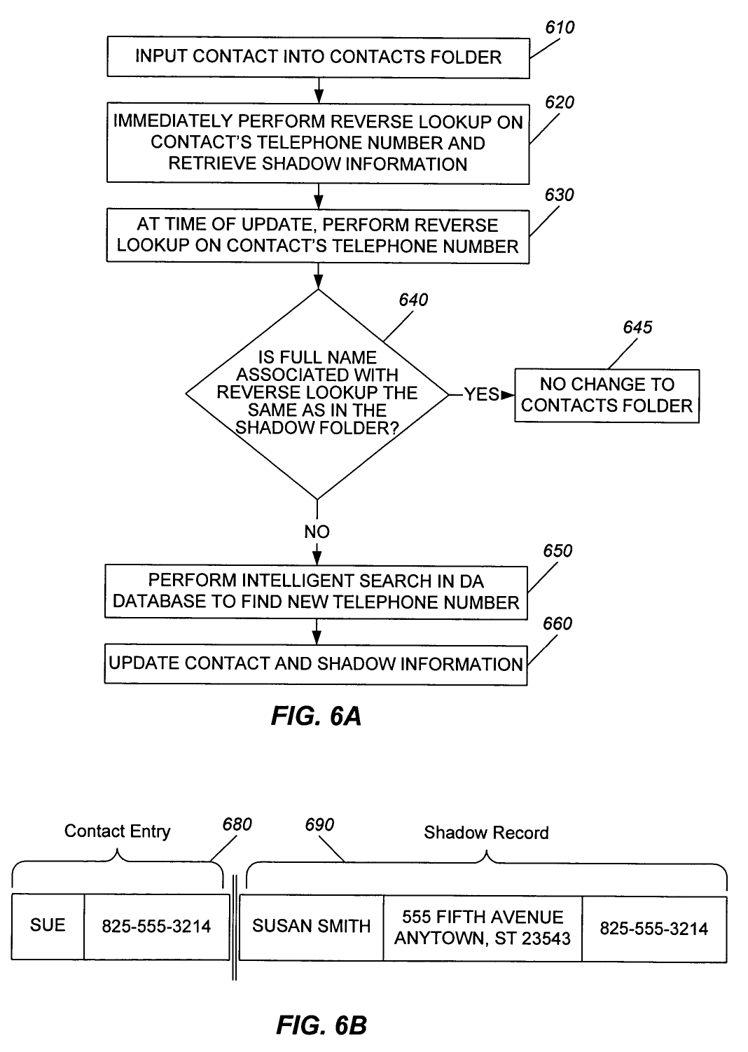

FIG. 6A is a flowchart illustrating how such a methodology may operate. First, in step 610, the user inputs to a contacts folder a contact having a telephone number 825-555-3124, but, for the user's own convenience, typically provides a name in short form, e.g., Sue for Susan Smith, or an alias only understood by the user. If no other information were known about the contact, when the user's next update occurs, e.g., six months later, the information assistance service may perform a reverse lookup on 825-555-3124, but if no entry comes up, the information assistance service will be unable to update the listing. Step 620 anticipates this problem, and at the time the user inputs the contact in the contacts folder, the information assistance service performs a reverse lookup on the telephone number in the DA database and derives the full name of the individual or business associated with that number, and possibly the address associated with that number, and places the information in the shadow record. An example of such information is shown in FIG. 6B. Contact entry 680 includes two pieces of information—a short name and a telephone number. Shadow record 690, created by performing a reverse lookup on 825-555-3124, includes a full name, address and telephone number. Six months later, at the time of the update, in step 630, the information assistance service may perform a reverse lookup on the telephone number and in step 640 compare the information associated with that telephone number to that stored in the shadow record. If, in step 645, the information is the same, no updating is necessary. If the information is not the same, in step 650 the information assistance service may perform an intelligent search in the DA database for the contact's new telephone number, based on the information in the shadow record. One such intelligent search method is described, e.g., in commonly-assigned, co-pending U.S. application Ser. No. 10/427,650, “Technique For Searching For Contact Information Concerning Desired Parties,” filed Apr. 30, 2003, incorporated herein by reference. This search method conducts a number of searches based on variations of criteria derived from information about a contact. Search results corresponding to the criteria variations are then analyzed, with each search result being assigned a confidence measure reflecting how likely the search results contain the updated information. Once the new information is found, in step 660, the contact information and shadow record information are updated.

As with the second methodology, there may be different costs associated with the frequency of the updates. If the update is not very frequent, there is more of a chance that the contact's information will have changed, and thus it would be more difficult to determine the correct, updated information. The information assistance service may thus set update pricing to discourage such results.

This last updating methodology may also be used in combination with one of the first two methodologies. In some cases, a change to the DA database may not include a change pair, such as when a contact moves without leaving a forwarding telephone number or when a contact's phone is disconnected. In such cases, no new telephone number may be available to update the contacts folder, and there is no association between the old and new numbers. When that happens, the information assistance service may invoke the third methodology to find the updated information for the contact. In anticipation of such occurrences, it may be prudent in the first two methodologies described above to also derive a shadow record at the time a user inputs a contact into the contacts folder.

In the present invention, the user can specify in a user profile the frequency with which each contact should be updated. This may depend on the rates charged by the information assistance service for the updating. The information assistance service can then decide how best (i.e., which of the above-described methods to use) to update the listings based on the user's preferences. A user may also be given different notification options with respect to updating the user's database. For instance, one user may want the information assistance service to notify him or her first of any changes to the contacts' listings before the information assistance service makes the change, with the user retaining global or item-by-item approval power over each change. Another user may want the information assistance service to make the changes first and then notify the user. And another user may not want to be notified at all of the changes made, or may just want to be notified the next time he or she logs in to the information assistance service account or contacts the information assistance service.

Additional advantages and modifications of the invention will readily occur to those skilled in the art. For instance, the invention could be used to update contacts folders kept at a number of different places or by different communication devices, such as a user's laptop, PDA, telephone, or at the information/call center. The ability to synchronize multiple repositories of contact information is disclosed, e.g., in commonly-assigned, co-pending U.S. application Ser. No. 10/631,938, “Technique for Synchronizing Data in User Device Through an Information Service,” filed Jul. 31, 2003, incorporated herein by reference.

Moreover, based on the disclosure heretofore, it is apparent that the invention can be used to update more than just telephone numbers—it can also update other information associated with a user, such as a postal address, an e-mail address, or a name. Occasionally, people change residences and/or businesses change locations without changing their telephone numbers. In such cases, instead of tracking and indexing changes to telephone numbers alone, the invention can also track and index changes to addresses. In addition, the information contained in the shadow record can contain the name, postal address, telephone number, and e-mail address. Generally, the name will not change, but occasionally, such as when someone gets married, even the name will change. Such changes can be discovered by performing a reverse lookup on the telephone number or address, or by looking up the person by name and comparing information in the shadow record with the newly received information.

Information/call center 101 is disclosed herein in a form in which various functions are performed by discrete functional blocks. However, any one or more of these functions could equally well be embodied in an arrangement in which the functions of any one or more of those blocks or, indeed, all of the functions thereof are realized, for example, by one or more appropriately programmed processors.

Therefore, the present invention in its broader aspects is not limited to the specific embodiments, details, and representative devices shown and described herein. Accordingly, various changes, substitutions, and alterations may be made to such embodiments without departing from the spirit or scope of the general inventive concept as defined by the appended claims.

1. A method for use by an information assistance service to update a database associated with a user, comprising:
maintaining the database associated with the user;
maintaining a directory database containing information accessible to the public;
receiving changes to the directory database;
comparing trackable information in the database associated with the user with the changes to the directory database; and
replacing the trackable information in the database associated with the user with new information if the trackable information is included within the changes to the directory database.

2. The method according to claim 1, wherein the trackable information is a telephone number.

3. The method according to claim 1, wherein the trackable information is a postal address.

4. The method according to claim 1, wherein the trackable information is an e-mail address.

5. The method according to claim 1, wherein the trackable information is a name.

6. The method according to claim 1, further comprising notifying the owner of the database associated with the user before replacing the trackable information.

7. The method according to claim 6, wherein the owner of the database associated with the user approves the replacement on a global or item-by-item basis.

8. The method according to claim 1, further comprising notifying the owner of the database associated with the user of the replacement made.

9. The method according to claim 1, wherein the update is performed substantially as soon as changes to the directory database are received.

10. The method according to claim 1, wherein the update is performed less frequently than changes to the directory database are received.

11. The method according to claim 10, further comprising keeping track of a sequence of changes made to the directory database and associated with the trackable information.

12. A method for use by an information assistance service to update a database associated with a user, comprising:
maintaining the database associated with the user;
maintaining a directory database containing information accessible to the public;
receiving changes to the directory database;
keeping track of a sequence of received changes associated with trackable information;
comparing the trackable information in the database associated with the user with the tracked changes to the directory database; and
replacing the trackable information in the database associated with the user with new information if the trackable information is included within the tracked changes to the directory database.

13. The method according to claim 12, wherein the trackable information is a telephone number.

14. The method according to claim 12, wherein the trackable information is a postal address.

15. The method according to claim 12, wherein the trackable information is an e-mail address.

16. The method according to claim 12, wherein the trackable information is a name.

17. The method according to claim 12, further comprising notifying the owner of the database associated with the user before replacing the trackable information.

18. The method according to claim 17, wherein the owner of the database associated with the user approves the replacement on a global or item-by-item basis.

19. The method according to claim 12, further comprising notifying the owner of the database associated with the user of the replacement made.

20. The method according to claim 12, further comprising using the trackable information to obtain secondary information associated with the contact, wherein replacing the trackable information comprises searching the directory database for new trackable information based on the secondary information.

21. The method according to claim 20, further comprising replacing the trackable information in the database associated with the user with new trackable information based on the search.

22. A method for use by an information assistance service to update a database associated with a user, comprising:
maintaining the database associated with the user;
receiving trackable information associated with a contact;
using the trackable information to obtain secondary information associated with the contact; and
using the trackable information to obtain additional secondary information associated with the contact,
wherein if the additional secondary information differs from the secondary information, updating the trackable information.

23. The method according to claim 22, wherein updating the trackable information comprises searching a directory database, containing information accessible to the public, for new trackable information based on the secondary information.

24. The method according to claim 23, further comprising replacing the trackable information in the database associated with the user with new information based on the search.

25. A system for use by an information assistance service to update a database associated with a user, comprising:
an interface for receiving changes to a directory database containing information accessible to the public;
a processor for comparing trackable information in the database associated with the user with the changes to the directory database; and
a mechanism for replacing the trackable information in the database associated with the user with new information if the trackable information is included within the changes to the directory database.

26. The system according to claim 25, wherein the trackable information is a telephone number.

27. The system according to claim 25, wherein the trackable information is a postal address.

28. The system according to claim 25, wherein the trackable information is an e-mail address.

29. The system according to claim 25, wherein the trackable information is a name.

30. The system according to claim 25, wherein the owner of the database associated with the user is notified before the trackable information is replaced.

31. The system according to claim 30, wherein the owner of the database associated with the user approves the replacement on a global or item-by-item basis.

32. The system according to claim 25, wherein the owner of the database associated with the user is notified after the trackable information is replaced.

33. The system according to claim 25, wherein the update is performed substantially as soon as changes to the directory database are received.

34. The system according to claim 25, wherein the update is performed less frequently than changes to the directory database are received.

35. The system according to claim 25, further comprising keeping track of changes made to the directory database.
